(19) United States
(12) Patent Application Publication
(10) Pub. No.: US 2011/0127955 A1
(43) Pub. Date: Jun. 2, 2011

(54) WIRELESS RECHARGEABLE BATTERY

(75) Inventors: Yen-Chih Chen, Taipei City (TW); Yi-Hsun Lin, Taipei City (TW); Wei-Chih Shih, Taipei City (TW)

(73) Assignee: COMPAL ELECTRONICS, INC., Taipei City (TW)

(21) Appl. No.: 12/953,468

(22) Filed: Nov. 24, 2010

Related U.S. Application Data
(60) Provisional application No. 61/265,336, filed on Nov. 30, 2009.

(51) Int. Cl. H02J 7/00

(52) U.S. Cl. 320/108

(57) ABSTRACT

A wireless rechargeable battery adapted to receive energy from a wireless power supply device wirelessly is provided. The wireless charge battery includes a battery unit, a wireless charging module, and an indicator. The wireless charging module is coupled to the battery unit to receive energy from the wireless power supply device wirelessly and transform the energy to electricity so as to charge the battery unit. The indicator is coupled to the wireless charging module to display the operation state of the wireless charging module.

### CROSS-REFERENCE TO RELATED APPLICATION

This application claims the priority benefit of U.S. provisional application Ser. No. 61/265,336, filed on Nov. 30, 2009. The entirety of the above-mentioned patent application is hereby incorporated by reference herein and made a part of this specification.

### BACKGROUND OF THE INVENTION

1. Field of the Invention

The present invention relates to a wireless rechargeable battery.

2. Description of Related Art

Common electronic devices (for example, notebook computers) typically employ a power supply that connects with an alternating current power source to supply direct current power. In order to supply the direct current power to an electronic device, one must carry the power supply together with the electronic device, which causes inconvenience in use. It is believed to be a prospective solution to replace the power supply with a wireless power supply technology to supply power to the electronic device.

### SUMMARY OF THE INVENTION

The present invention is directed to a wireless rechargeable battery capable of wirelessly receiving electricity from a wireless power supply device.

The present invention provides a wireless rechargeable battery adapted to wirelessly receive energy from a wireless power supply device. The wireless rechargeable battery includes a battery unit, a wireless charging module and an indicator. The wireless charging module is coupled to the battery unit to wirelessly receive energy supplied by the wireless power supply device and transform the energy into electricity to charge the battery unit. The indicator is coupled to the wireless charging module to display the operation state of the wireless charging module.

In view of the foregoing, in the present invention, the indicator is coupled to the wireless recharging module to display the operation state of the wireless charging module.

In order to make the aforementioned and other features and advantages of the invention more comprehensible, embodiments accompanying figures are described in detail below.

### BRIEF DESCRIPTION OF THE DRAWINGS

FIG. 1 illustrates a wireless rechargeable battery according to one embodiment of the present invention.

FIG. 2 illustrates a wireless rechargeable battery according to another embodiment of the present invention.

FIG. 3A and FIG. 3B illustrate a wireless rechargeable battery according to another embodiment of the present invention.

FIG. 4 illustrates a wireless rechargeable battery according to another embodiment of the present invention.

FIG. 5 illustrates a wireless rechargeable battery according to another embodiment of the present invention.

FIG. 6 illustrates a wireless rechargeable battery according to still another embodiment of the present invention.

### DESCRIPTION OF THE EMBODIMENTS

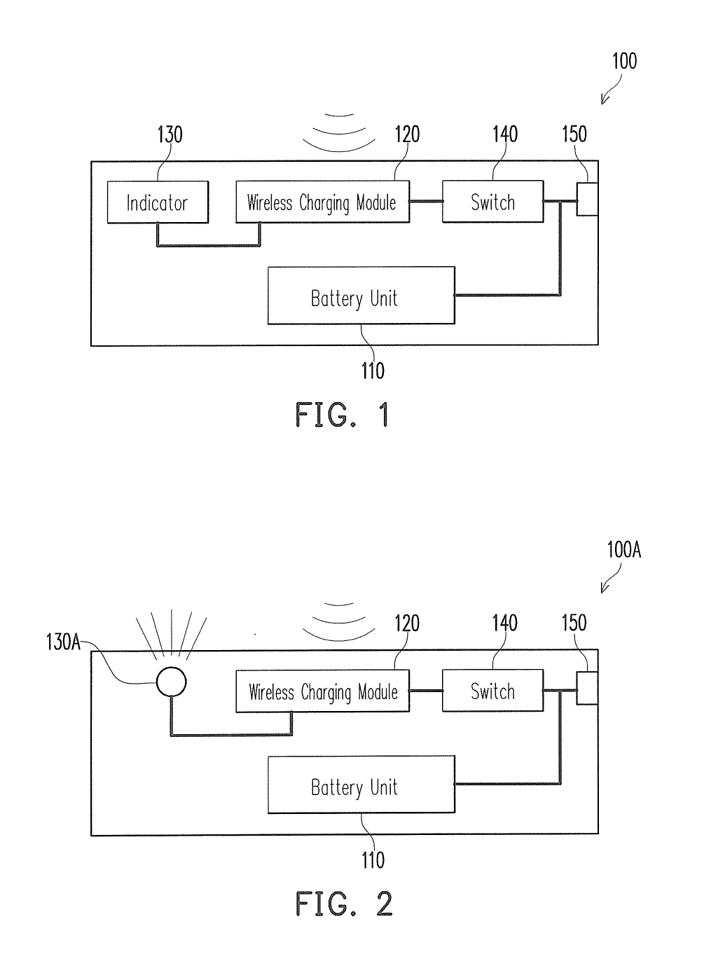

FIG. 1 illustrates a wireless rechargeable battery according to one embodiment of the present invention. Referring to FIG. 1, the wireless rechargeable battery 100 of the present embodiment is adapted to wirelessly receive energy from a wireless power supply device. The wireless rechargeable battery 100 includes a battery unit 110, a wireless charging module 120, and an indicator 130. The battery unit 110 may be a battery pack. The wireless charging module 120 is coupled to the battery unit 110 to wirelessly receive energy from the wireless power supply device and transform this energy into electricity so as to charge the battery unit 110. The energy supplied by the wireless power supply device is magnetic energy transformed from electricity. The indicator 130 is coupled to the wireless charging module 120 to display the operation state of the wireless charging module 120.

In the present embodiment, the wireless rechargeable battery further includes a switch 140. The switch 140 is coupled to the wireless charging module 120 for activating or deactivating the wireless charging module 120 upon receiving an external instruction. Therefore, a user may activate or deactivate the wireless charging module 120 with this switch 140.

In the present embodiment, the wireless rechargeable battery 100 further includes an electricity transmitting port 150. The electricity transmitting port 150 is coupled to the battery unit 110 to output the electricity to an electricity receiving object such as a notebook computer host or the like.

FIG. 2 illustrates a wireless rechargeable battery according to another embodiment of the present invention. Referring to FIG. 2, the indicator of the wireless rechargeable battery 110A is an indicating lamp 130A. Therefore, based on whether the indicating lamp 130A is emitting light or emitting frequency of the indicating lamp 130A, the user can determine the operation state of the wireless charging module 120, such as, whether the wireless charging module 120 is operating, the energy transmitting strength between the wireless power supply device and the wireless charging battery 100A, or the electricity transforming rate of the wireless charging module 120.

In one embodiment, the user may determine whether the wireless charging module 120 is normally operating based on whether the indicating lamp 130A is emitting light.

In one embodiment, the user may determine the electricity transforming rate of the wireless charging module 120 based on the emitting frequency of the indicating lamp 130A. The electricity transforming rate refers to the rate of energy transforming from the magnetic energy into electricity. Specifically, when the wireless charging module 120 continuously supplies power, the indicating lamp 130A intermittently emits light; when the electricity transforming rate of the wireless charging module 120 is lower than a preset value, the indicating lamp 130A continuously emits light.

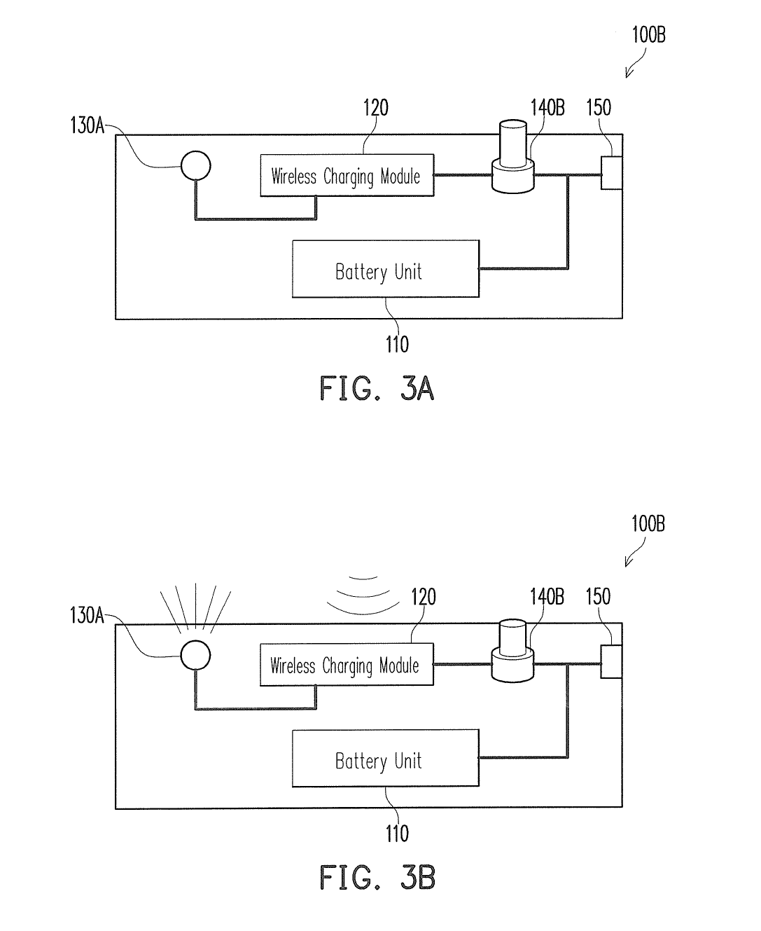

FIG. 3A and FIG. 3B illustrate a wireless rechargeable battery according to another embodiment of the present invention. Referring to FIG. 3A, as compared with the embodiment of the FIG. 2, the switch of wireless rechargeable battery 100B is a push switch 140B that can operate upon being pushed. Therefore, the user may push the push switch 140B to activate or deactivate the wireless charging module 120.

Specifically, in FIG. 3A, the push switch 140B is not pushed such that the wireless charging module 120 is deactivated and the indicating lamp 130A does not emit light. On the contrary, in FIG. 3B, the push switch 140B is pushed such that the wireless charging module 120 is activated and the indicating lamp 130A emits light.

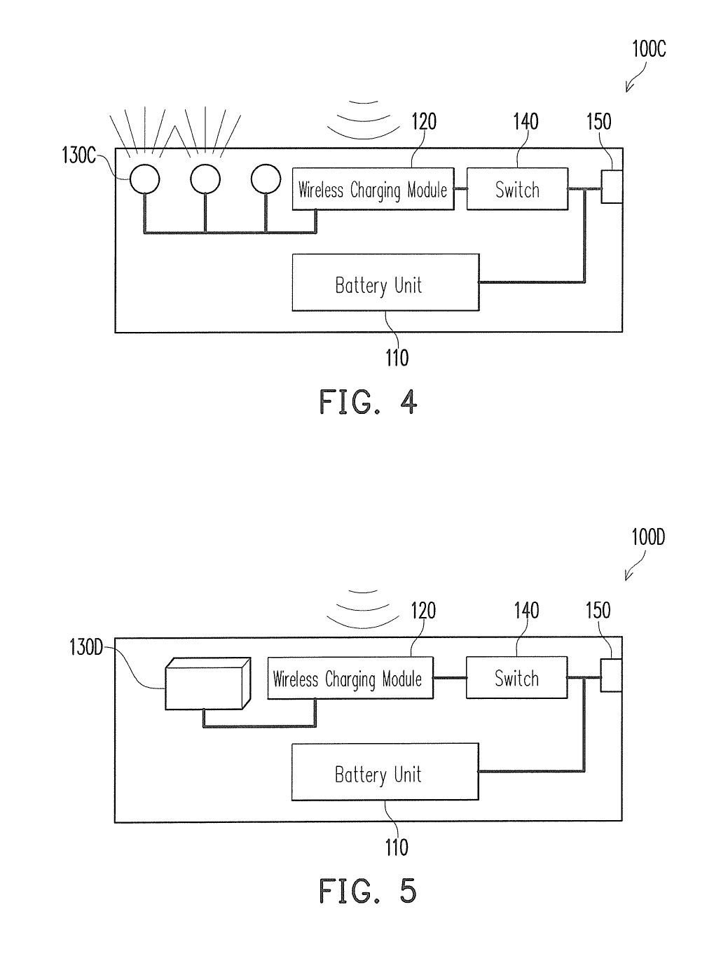

FIG. 4 illustrates a wireless rechargeable battery according to another embodiment of the present invention. Referring to FIG. 4, the indicator of the wireless rechargeable battery 100C of the present embodiment includes a plurality of indicating lamps 130C (three lamps are shown in FIG. 4). Therefore, based on whether the indicating lamps 130C are emitting light or the emitting frequency of the indicating lamps 130C, the user may determine the operation state of the wireless charging module 120, such as, whether the wireless charging module 120 is operating or the electricity transforming rate of the wireless charging module 120. The electricity transforming rate refers to the rate of energy transforming from magnetic energy into electricity.

In one embodiment, the number of indicating lamps 130C to be emitting light among all the indicating lamps 130C can be determined based on the electricity transforming rate of the wireless charging module 120.

FIG. 5 illustrates a wireless rechargeable battery according to another embodiment of the present invention. Referring to FIG. 5, the indicator of the wireless rechargeable battery 100D of the present embodiment is a character display 130D. Therefore, the user may determine the operation state of the wireless charging module 120, such as, whether the wireless charging module 120 is operating or the electricity transforming rate of the wireless charging module 120, based on the characters displayed on the character display 130D.

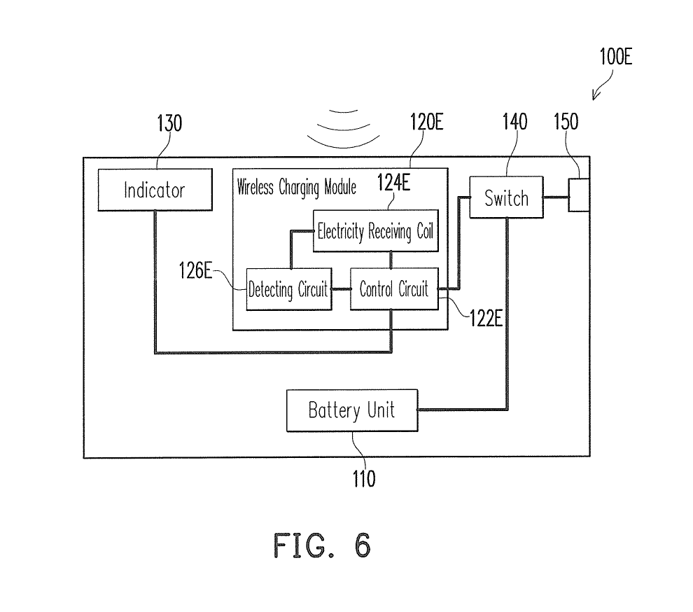

FIG. 6 illustrates a wireless rechargeable battery according to another embodiment of the present invention. Referring to FIG. 6, the wireless charging module 120E of the wireless rechargeable battery 100E of the present embodiment includes a control circuit 122E, an electricity receiving coil 124E, and a detecting circuit 126E. The control circuit 122E is coupled to the indicator 130. The electricity receiving coil 124E is coupled to the control circuit 122E to wirelessly receive electricity. The detecting circuit 126E is coupled to the control circuit 122E and the electricity receiving coil 124E, to detect the operation state of the electricity receiving coil 124E. The control circuit 122E causes the display 130 to display the operation state of the electricity receiving coil 124E based on the detecting result of the detecting circuit 126E.

In summary, in embodiments of the present invention, the indicator is coupled to the wireless recharging module to display the operation state of the wireless charging module. Therefore, the user may determine the operation state of the wireless charging module, such as, whether the wireless charging module is operating or the electricity transforming rate of the wireless charging module, based on the displaying of the indicator, thereby facilitating the use of the wireless rechargeable battery.

What is claimed is:

1. A wireless rechargeable battery adapted to wirelessly receive energy from a wireless power supply device, the wireless rechargeable battery comprising:
a battery unit;
a wireless charging module coupled to the battery unit to wirelessly receive energy supplied by the wireless power supply device and transform the energy into electricity to charge the battery unit; and
an indicator coupled to the wireless charging module to display the operation state of the wireless charging module.

2. The wireless rechargeable battery according to claim 1, further comprising:
a switch coupled to the wireless charging module to activate or deactivate the wireless charging module upon receiving an external instruction.

3. The wireless rechargeable battery according to claim 1, wherein the indicator is an indicating lamp.

4. The wireless rechargeable battery according to claim 1, wherein the indicator comprises a plurality of indicating lamps.

5. The wireless rechargeable battery according to claim 1, wherein the indicator is a character display.

6. The wireless rechargeable battery according to claim 1, wherein the wireless charging module comprises:
a control circuit coupled to the indicator;
an electricity receiving coil coupled to the control circuit to wirelessly receive the energy and transform the energy into electricity; and
a detecting circuit coupled to the control circuit and the electricity receiving coil to detect the operation state of the electricity receiving coil;
wherein the control circuit causes the indicator to display the operation state of the electricity receiving coil based on the detecting result of the detecting circuit.

7. The wireless rechargeable battery according to claim 1, further comprising:
an electricity transmitting port coupled to the battery unit and adapted to output the electricity to an electricity receiving object.

8. The wireless rechargeable battery according to claim 1, wherein the energy is magnetic energy.

9. The wireless rechargeable battery according to claim 1, wherein the operation state of the wireless charging module comprises an electricity transforming rate of the wireless charging module.

10. The wireless rechargeable battery according to claim 1, wherein the operation state of the wireless charging module comprises an energy transmitting strength between the wireless power supply device and the wireless rechargeable battery.
